(19) United States
(12) Patent Application Publication
(10) Pub. No.: US 2023/0250222 A1
(43) Pub. Date: Aug. 10, 2023

(54) CATALYSTS FOR CROSSLINKING EPOXY RESINS

(71) Applicant: SOCPRA SCIENCES ET GÉNIE S.E.C., Sherbrooke (CA)

(72) Inventors: Jérôme CLAVERIE, Canton de Hatley (CA); Louis SCHUTZ, Saint-Pair-sur-Mer (FR); Forouzan KAZEMI, Laval (CA)

(21) Appl. No.: 18/003,548

(22) PCT Filed: Jun. 30, 2021
(86) PCT No.: PCT/CA2021/050900

§ 371 Date: Dec. 28, 2022

Related U.S. Application Data
(60) Provisional application No. 63/047,775, filed on Jul. 2, 2020.

(51) Int. Cl. C08G 59/68; B01J 27/053; C08G 59/50

(52) U.S. Cl. CPC C08G 59/687; B01J 27/053; C08G 59/502; B01J 2523/3706

(57) ABSTRACT

A compound of formula (I): MX_{y}, alone or in combination with a compound of formula (II): MX_{z}L, useful as a catalyst for accelerating the crosslinking of a reactive epoxy monomer, oligomer or polymer to form an epoxy thermoset resin, is provided. In formulas (I) and (II), M represents a rare earth metal cation, X represents an anion of formula R—Z—O″, wherein R represents a hydrocarbon radical optionally substituted with one or more halogen atom and —Z— represents —S(═O)₂— or —O—S(═O)₂—, z=y+1, and L represents Na⁺, H⁺, or a combination thereof.

### CROSS REFERENCE TO RELATED APPLICATIONS

This application claims benefit, under 35 U.S.C. § 119(e), of U.S. provisional application Ser. No. 63/047,775, filed on Jul. 2, 2020. All documents above are incorporated herein in their entirety by reference.

### FIELD OF THE INVENTION

The present invention relates to catalysts for accelerating the crosslinking of a reactive epoxy monomer, oligomer or polymer to form an epoxy thermoset resin.

### BACKGROUND OF THE INVENTION

Industrial thermosets include melamine formaldehyde, urea formaldehyde, polyesters, phenolic resins, alkyds, polyurethanes, epoxy resins, and the like. These resins are widely used in a myriad of applications such as adhesives, protective and decorative coatings, paints, inks, fibers, films, plastic composites, elastomers, and structural plastics.

Among the above-cited thermosets, epoxy resins occupy a preponderant position. They are widely used, inter alia, for example in appliances, automobiles, marine applications, industrial coatings, decorative coatings such as topcoats or primers, industrial tooling and composites, semiconductor encapsulation, 3D printing, printed circuit boards and aerospace components. They are used as adhesives, reinforcement materials, sealants, coatings, 3D printing and electronic encapsulation matrix. Numerous state-of-the-art or mundane technologies rely on epoxy resins. For example, all electronic components are surrounded (encapsulated) in a black structure made of epoxy (so called electronic epoxy). Composite piece in airplanes, trains or cars are glued to a metallic frame with an epoxy (so called structural epoxy). Currently, the best anti-corrosion coatings are epoxy coatings.

Epoxy resins are essential products in the development of composites, adhesives, coatings, encapsulants, etc. These resins are obtained by curing an epoxy monomer, oligomer, or polymer together with a hardener. At the start of the reaction, the mixture is liquid (or pasty), and it turns into a hard solid.

The majority of epoxy formulations are petroleum-based. Recently, the industry is interested in the use of bio-based products to manufacture epoxy formulations. Unfortunately, most bio-based epoxies harden very slowly.

### SUMMARY OF THE INVENTION

In accordance with the present invention, there is provided:
1. A catalyst for accelerating the crosslinking of a reactive epoxy monomer, oligomer or polymer to form an epoxy thermoset resin, wherein said catalyst is a compound of formula (I):

MX_{y} (I)
wherein:
   M represents a rare earth metal cation;
   y represents an integer from 1 to 4 equal to the valency of the rare earth metal cation, and
   X represents an anion of formula R—Z—O⁻, wherein:
      R represents an alkyl, alkenyl, alkynyl, alkenynyl, cycloalkyl, cycloalkenyl, cycloalkynyl, cycloalkenynyl, aryl, heteroaryl, or alkylaryl radical, each of which being optionally substituted with one or more halogen atom, and
      —Z— represents —S(═O)₂— or —O—S(═O)₂—.
2. The catalyst of item 1, wherein —Z— represents —O—S(═O)₂—.
3. The catalyst of item 1 or 2, wherein M represents Sc, Y or a metal of the lanthanide series; preferably a metal of the lanthanide series; more preferably La, Ce, Pr, Nd, Sm, Tb, or Lu; yet more preferably La, Ce, Pr, Nd, or Sm; and most preferably La.
4. The catalyst of any one of items 1 to 3, wherein the hydrocarbon chains of the alkyl, alkenyl, alkynyl, alkenynyl, and alkylaryl radicals re linear.
5. The catalyst of any one of items 1 to 4, wherein the hydrocarbon chain of the alkyl, alkenyl, alkynyl, alkenynyl, and alkylaryl radicals contain between 1 and 18 carbon atoms, preferably between 6 and 18 carbon atoms, more preferably between 8 and 16 carbon atoms, yet more preferably between 10 and 14 carbon atoms, and most preferably 12 carbon atoms.
6. The catalyst of any one of items 1 to 5, wherein the ring(s) of the cycloalkyl, cycloalkenyl, cycloalkynyl, cycloalkenynyl, aryl, heteroaryl, and alkylaryl radicals comprise between 4 and 8 ring atoms, preferably 5 or 6 ring atoms, and more preferably 6 ring atoms.
7. The catalyst of any one of items 1 to 6, wherein the cycloalkyl, cycloalkenyl, cycloalkynyl, cycloalkenynyl, aryl, heteroaryl, and alkylaryl radicals comprise only one ring.
8. The catalyst of any one of items 1 to 7, wherein R represents an alkyl or alkylaryl radical, preferably an alkyl radical.
9. The catalyst of any one of items 1 to 8, wherein R represents dodecyl or dodecylphenyl, preferably dodecyl.
10. The catalyst of any one of items 1 to 9, wherein the halogen atom is a fluorine atom.
11. The catalyst of any one of items 1 to 10, wherein the alkyl, alkenyl, alkynyl, alkenynyl, cycloalkyl, cycloalkenyl, cycloalkynyl, cycloalkenynyl, aryl, and alkylaryl radicals are perfluorinated.
12. The catalyst of any one of items 1 to 10, wherein the alkyl, alkenyl, alkynyl, alkenynyl, cycloalkyl, cycloalkenyl, cycloalkynyl, cycloalkenynyl, aryl, and alkylaryl radicals are unsubstituted.
13. The catalyst of any one of items 1 to 12, wherein X represents:
   an alkylaryl sulfonate (alkylaryl-S(═O)₂—O⁻) anion, preferably dodecylbenzene sulfonate; or
   an alkyl sulfate (alkyl-O—S(═O)₂—O⁻) anion, preferably dodecyl sulfate.
14. The catalyst of any one of items 1 to 13, wherein X represents an alkyl sulfate (alkyl-O—S(═O)₂—O⁻) anion, preferably dodecyl sulfate.
15. The catalyst of any one of items 1 to 13, being a rare earth metal dodecyl sulfate or a rare earth metal dodecylbenzene sulfonate, preferably lanthanum dodecyl sulfate or lanthanum dodecylbenzene sulfonate, most preferably lanthanum dodecyl sulfate.
16. The catalyst of any one of items 1 to 15, further comprising a compound of formula (II):

MX_{z}L (II)
wherein:
   L represents Na⁺, H⁺, or a combination thereof;
   z is egal to y+1, and
   M, X, and y are as defined above.
17. The catalyst of item 16, wherein L represents a combination Na⁺ and H⁺.
18. An epoxy thermosetting resin formulation comprising a reactive epoxy monomer, oligomer or polymer and the catalyst of any one of items 1 to 17.
19. The formulation of item 18, further comprising one or more additives
20. The formulation of item 19, wherein the additives are selected from antioxidants, viscosity modifiers, processing aids, releasing agents, flame-retardants, dyes, pigments, and/or UV-stabilizers.
21. The formulation of any one of items 18 to 20, further comprising fibers, such as glass fibers, carbon fibers, or carbon nanotubes.
22. The formulation of any one of items 18 to 21, being a one-part formulation or a two-part formulation.
23. The formulation of any one of items 18 to 22, wherein the reactive epoxy monomer, oligomer or polymer is:
   a bisphenol-based epoxy resin,
   a novolak-based epoxy resin,
   an aliphatic epoxy resin, such as a cycloaliphatic epoxy resin,
   a halogenated epoxy resin, or
   a glycidyl amine epoxy resin.
24. The formulation of any one of items 18 to 23, wherein the reactive epoxy monomer, oligomer or polymer is:
   a bisphenol-based epoxy resin, preferably Bisphenol A diglycidyl ether, or
   an aliphatic epoxy resin, preferably produced by the conversion of limonene dioxide.
25. The formulation of any one of items 18 to 24, further comprising one or more hardener.
26. The formulation of item 25, wherein the hardener is a polyfunctional amine, an acid, an acid anhydride, a phenol, an alcohol or a thiol; preferably a polyfunctional amine; more preferably Epikure® 3251 or polyethylenimine.
27. Use of the catalyst of any one of items 1 to 17 for accelerating the crosslinking of a reactive epoxy monomer, oligomer or polymer to form an epoxy thermoset resin.
28. A method of crosslinking a reactive epoxy monomer, oligomer or polymer to form an epoxy thermoset resin, the method comprising contacting the catalyst of any one of items 1 to 17 with the reactive epoxy monomer, oligomer or polymer and optionally, a hardener.
29. A method of accelerating the crosslinking of a reactive epoxy monomer, oligomer or polymer to form an epoxy thermoset resin, the method comprising contacting the catalyst of any one of items 1 to 17 with the reactive epoxy oligomer or polymer and optionally, a hardener.

### DETAILED DESCRIPTION OF THE INVENTION

Turning now to the invention in more details, there are provided:
a catalyst for accelerating the crosslinking of a reactive epoxy monomer, oligomer or polymer to form an epoxy thermoset resin, wherein said catalyst is a compound of formula (I) as described herein, alone or in combination with, preferably in combination with, a compound of formula (II) as described herein;
the use of this catalyst for accelerating the crosslinking of a reactive epoxy monomer, oligomer or polymer to form an epoxy thermoset resin;
an epoxy thermosetting resin formulation comprising a reactive epoxy monomer, oligomer or polymer and the above catalyst;
a method of crosslinking a reactive epoxy monomer, oligomer or polymer to form an epoxy thermoset resin, the method comprising contacting the above catalyst with the reactive epoxy monomer, oligomer or polymer and optionally, a hardener; and
a method of accelerating the crosslinking of a reactive epoxy monomer, oligomer or polymer to form an epoxy thermoset resin, the method comprising contacting the above catalyst with the reactive epoxy oligomer or polymer and optionally, a hardener.

Indeed, the present inventors have found that the compounds of formula (I) as described herein, alone or in combination with, preferably in combination with, a compound of formula (II) as described herein have excellent performances for accelerating the crosslinking of reactive epoxy monomers/oligomers/polymers to form epoxy thermoset resins.

One of the most important parameters of an epoxy thermosetting resin formulation is the time it takes for the mixture to go from liquid to solid (gel time: t_{gel}) and finally to a hard, dry solid (drying time: t_{dry}) For example, when preparing an epoxy floor, these times should ideally be as short as possible so to make it possible to walk on the floor as quickly as possible.

A catalyst (also called accelerator) is typically added to epoxy formulations. Such catalysts are species that accelerate the crosslinking reaction and therefore to reduce t_{gel} and t_{dry}. The compounds of formula (I) alone or in combination with, preferably in combination with, compounds of formula (II) are catalysts (i.e. accelerators) that greatly accelerate the crosslinking of reactive epoxy monomers/oligomers/polymers to form epoxy thermoset resins and thus greatly reduce the drying time (t_{dry}) required to form the epoxy thermoset resin as well as t_{gel}—see the Examples below. In addition, these compounds are cheap, easy to prepare, and easy to scale up.

Herein, “reactive epoxy monomers, oligomers or polymers”, also known as polyepoxides, are a class of reactive monomers, oligomers, and polymers which contain epoxide groups. These monomers, oligomers, and polymers can be cross-linked either with themselves through catalytic homopolymerisation, or with a wide range of co-reactants, which are often referred to as “hardeners” or “curatives”. The cross-linking reaction irreversibly produces an infusible, insoluble polymer 3D network. This crosslinking reaction of the reactive epoxy prepolymers or polymers with themselves or with hardeners produces a thermoset polymer, often with favorable mechanical properties and high thermal and chemical resistance. Herein, the thermoset polymer resulting of this crosslinking reaction is called an “epoxy thermoset resin”.

The catalyst of the invention is a compound of formula (I):

MX_{y} (I)

wherein:
M represents a rare earth metal cation;
y represents an integer from 1 to 4 equal to the valency of the rare earth metal cation, and
X represents an anion of formula R—Z—O⁻, wherein:
   R represents an alkyl, alkenyl, alkynyl, alkenynyl, cycloalkyl, cycloalkenyl, cycloalkynyl, cycloalkenynyl, aryl, heteroaryl, or alkylaryl radical, each of which being optionally substituted with one or more halogen atom, and
   —Z— represents —S(═O)₂— or —O—S(═O)₂—.

Rare earth metals are metals of group 3 of the periodic table including the metals of the lanthanide series (elements 57 to 71) and the actinide series (elements 89 to 103).

In preferred embodiments, M represents Sc, Y or a metal of the lanthanide series; preferably a metal of the lanthanide series; more preferably La, Ce, Pr, Nd, Sm, Tb, or Lu; yet more preferably La, Ce, Pr, Nd, or Sm; and most preferably La.

In preferred embodiments, the halogen atom is a fluorine atom.

In preferred embodiments, R represents an alkyl or alkylaryl radical, preferably an alkyl radical.

In embodiments, the alkyl, alkenyl, alkynyl, alkenynyl, cycloalkyl, cycloalkenyl, cycloalkynyl, cycloalkenynyl, aryl, and alkylaryl radicals are fluorinated, or even perfluorinated. In alternative preferred embodiments, the alkyl, alkenyl, alkynyl, alkenynyl, cycloalkyl, cycloalkenyl, cycloalkynyl, cycloalkenynyl, aryl, and alkylaryl radicals are unsubstituted.

When —Z— represents —S(═O)₂—, the compound of formula (I) is an alkyl or alkylaryl sulfonate of metal M. When —Z— represents —O—S(═O)₂—, the compound of formula (I) is an alkyl or alkylaryl sulfate of metal M.

In preferred embodiments, —Z— represents —O—S(═O)₂—, i.e. the compound of formula (I) is an alkyl or alkylaryl sulfate of metal M.

In preferred embodiments, X represents:
an alkylaryl sulfonate (alkylaryl-S(═O)₂—O⁻) anion, preferably dodecylbenzene sulfonate; or
an alkyl sulfate (alkyl-O—S(═O)₂—O⁻) anion, preferably dodecyl sulfate.

In more preferred embodiments, X represents an alkyl sulfate (alkyl-O—S(═O)₂—O⁻) anion, preferably dodecyl sulfate.

In preferred embodiments, the catalyst of the invention further comprises a compound of formula (II):

MX_{z}L (II)

wherein:
L represents Na⁺, H⁺, or a combination thereof;
z is egal to y+1, and
M, X, and y are as defined above.

In more preferred embodiments, L represents a combination Na⁺ and H⁺. This means that the catalyst simultaneously comprises compounds of formula MX_{z}Na and MX_{z}H.

A mixture of compounds of formulas I and II, wherein L represents a combination Na⁺ and H⁺, can be prepared by reacting a sodium sulfate of formula R—Z—O⁻ Na⁺ with a nitrate or chloride salt of the rare earth metal M in water at room temperature. For example:

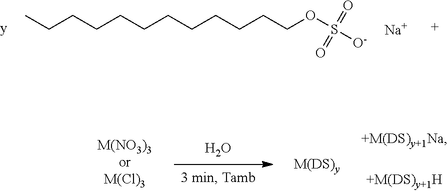

wherein DS represents dodecyl sulfate.

Herein, an “epoxy thermosetting resin formulation” is a formulation comprising the components necessary for producing an epoxy thermoset resin. Such formulation at least comprises at least one reactive epoxy monomer, oligomer, or polymer and the catalyst of the invention. In embodiments, one or more hardeners are also present.

In further embodiments, the epoxy thermosetting resin formulation of the invention may further comprise one or more additives to achieve desired processing properties or final properties. Non-limiting examples of additives include further catalysts (i.e. further accelerators), antioxidants, viscosity modifiers, processing aids, releasing agents, flame-retardants, dyes, pigments, and UV-stabilizers. These formulations can also comprise fibers, such as glass fibers, carbon fibers, and carbon nanotubes, to reinforce the resulting epoxy thermoset resin.

The crosslinking reaction of the epoxy thermosetting resin formulation to form an epoxy thermoset resin can be performed under the action of heat (thermal curing), under the action of light (photocuring), or spontaneously upon mixing a reactive epoxy prepolymer or polymer with a hardener. Therefore, epoxy thermosetting resin formulations are provided either as “one-part” or “two-part” formulations. In two-part formulations, one or more components are segregated from the other (typically the reactive epoxy prepolymer or polymer is kept separate from the hardener). This is generally necessary for formulations in which curing is spontaneous but can be used in all types for most types of epoxy thermosetting resin formulations. In one-part formulations, all the components of the epoxy thermosetting resin formulation are in contact (typically in admixture) with one another. The epoxy thermosetting resin formulation of the invention may be a one-part or a two-part formulation.

The reactive epoxy monomers, oligomers or polymers may be any such compound known to be useful for producing epoxy thermoset resins. Non-limiting examples include:
bisphenol-based epoxy resins,
novolak-based epoxy resins,
aliphatic epoxy resins, including cycloaliphatic epoxy resins,
halogenated epoxy resins, and
glycidyl amine epoxy resins.

Bisphenol-based epoxy resins are the most common epoxy resins and are produced by reacting epichlorohydrin (ECH) with a bisphenol. Reaction with bisphenol A results in a resin called bisphenol A diglycidyl ether (BADGE or DGEBA). Bisphenol A-based resins are the most widely commercialized resins, but also other bisphenols are analogously reacted with epichlorohydrin, including for example Bisphenol F and brominated bisphenols brominated bisphenols. Higher molecular weight diglycidyl ethers (n≥1, n being the number of repeat unit) are formed by the reaction of the bisphenol A diglycidyl ether formed with further bisphenol A, this is called prepolymerization.

Novolaks are produced by reacting phenol with methanal (formaldehyde). Then, the reaction of epichlorohydrin and novolaks produces novolak-based epoxy resins comprising glycidyl residues, i.e. epoxidized novolaks, such as epoxyphenol novolak (EPN) or epoxycresol novolak (ECN).

There are two common types of aliphatic epoxy resins: those obtained by epoxidation of double bonds (including cycloaliphatic epoxides and epoxidized vegetable oils) and those formed by reaction with epichlorohydrin (glycidyl ethers and esters). This class of resin include:
Cycloaliphatic epoxides contain one or more aliphatic rings in the molecule on which the oxirane ring is contained (e.g. 3,4-epoxycyclohexylmethyl-3′,4′-epoxycyclohexane carboxylate). They are produced by the reaction of a cyclic alkene with a peracid.

Epoxidized vegetable oils are formed by epoxidation of unsaturated fatty acids by reaction with peracids. In this case, the peracids can also be formed in situ by reacting carboxylic acids with hydrogen peroxide.
Aliphatic glycidyl epoxy resins of low molar mass (mono-, bi- or polyfunctional) are formed by the reaction of epichlorohydrin with aliphatic alcohols or polyols (glycidyl ethers are formed) or with aliphatic carboxylic acids (glycidyl esters are formed). Representative structures of this class of products are butanediol diglycidyl ether and trimethylolpropane triglycidyl ether.
Cycloaliphatic epoxy resin containing one or more cycloaliphatic rings in the molecule (e.g. 3,4-epoxycyclohexylmethyl-3,4-epoxycyclohexane carboxylate).

Halogenated epoxy resins are admixed for special properties, in particular brominated and fluorinated epoxy resins are used. Brominated bisphenol A are derivatives thereof are used when flame retardant properties are required. Fluorinated epoxy resins have been investigated for some high performance applications, such as the fluorinated diglycidether 5-heptafluoropropyl-1,3-bis[2-(2,3-epoxypropoxy)hexafluoro-2-propyl]benzene.

Glycidylamine epoxy resins are higher functionality epoxies which are formed when aromatic amines are reacted with epichlorohydrine. Representative structures include triglycidyl-p-aminophenol and N,N,N′,N′-tetraglycidyl-bis-(4-aminophenyl)-methane

In preferred embodiment, the reactive epoxy prepolymers or polymers is:
a bisphenol-based epoxy resin, preferably Bisphenol A diglycidyl ether, and
an aliphatic epoxy resin, preferably produced by the conversion of limonene dioxide.

The hardener may be any hardener known to be useful for producing epoxy thermoset resins. These are compounds bearing two or more chemical groups that react with epoxy groups. In principle, any molecule containing a reactive hydrogen may react with the epoxide groups of the epoxy resin. Non-limiting typical classes of hardeners include polyfunctional amines, acids, acid anhydrides, phenols, alcohols and thiols (usually called mercaptan).

Polyfunctional primary amines form an important class of epoxy hardeners. Primary amines undergo an addition reaction with the epoxide group to form a hydroxyl group and a secondary amine. The secondary amine can further react with an epoxide to form a tertiary amine and an additional hydroxyl group. Use of a difunctional or polyfunctional amine forms a three-dimensional cross-linked network. Aliphatic, cycloaliphatic and aromatic amines are all employed as epoxy hardeners.

Epoxy resins can also be cured with cyclic anhydrides at elevated temperatures. Reaction occurs only after opening of the anhydride ring, e.g. by secondary hydroxyl groups in the epoxy resin.

Polyphenols, such as bisphenol A or novolacs can react with epoxy resins at elevated temperatures (130-180° C., 266-356° F.), normally in the presence of a catalyst. The resulting material has ether linkages and displays higher chemical and oxidation resistance than typically obtained by curing with amines or anhydrides.

Also known as mercaptans, thiols contain a sulfur which reacts very readily with the epoxide group, even at ambient or sub-ambient temperatures.

In preferred embodiment, the hardener is polyfunctional amine, more preferably Epikure® 3251 or polyethylenimine.

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted. In contrast, the phrase “consisting of” excludes any unspecified element, step, ingredient, or the like. The phrase “consisting essentially of” limits the scope to the specified materials or steps and those that do not materially affect the basic and novel characteristic(s) of the invention.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

Similarly, herein a general chemical structure, such as Formulas (I), with various substituents (M, X, R, Z, etc.) and various radicals (alkyl, halogen atom, etc.) enumerated for these substituents is intended to serve as a shorthand method of referring individually to each and every molecule obtained by the combination of any of the radicals for any of the substituents. Each individual molecule is incorporated into the specification as if it were individually recited herein. Further, all subsets of molecules within the general chemical structures are also incorporated into the specification as if they were individually recited herein.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Herein, all chemical terms have their ordinary meaning in the art. For more certainty, herein the following terms have the following definitions:

| Terms | Definitions |
|---|---|
| alkane | aliphatic hydrocarbon of general formula CₙH₂ₙ₊₂ |
| alkyl | monovalent alkane radical of general |
| | formula —CₙH₂ₙ₊₁ |
| alkenyl | monovalent alkene radical, similar to an alkyl |
| | but comprising at least one double bond |
| alkynyl | monovalent alkyne radical, similar to an alkyl |
| | but comprising at least one triple bond |
| alkenynyl | monovalent alkenyne radical, similar to an |
| | alkyl but comprising at least one double bond |
| | and at least one triple bond |
| cycloalkane | monovalent saturated aliphatic hydrocarbon |
| | radical of general formula CₙH₂ₙ, wherein the |
| | carbon atoms are arranged in a ring (also |
| | called cycle). |
| cycloalkyl | monovalent cycloalkane radical of general |
| | formula —CₙH₂ₙ₋₁ |
| cycloalkenyl | monovalent cycloalkene radical, similar to a |
| | cycloalkyl but comprising at least one double |
| | bond |
| cydoalkynyl | monovalent cycloalkyne radical, similar to a |
| | cycloalkyl but comprising at least one triple |
| | bond |
| cydoalkenynyl | monovalent cycloalkenyne radical, similar to a |
| | cycloalkyl but comprising at least one double |
| | bond and at least one triple bond |
| arene | aromatic hydrocarbon presenting alternating |
| | double and single bonds between carbon atoms |
| | arranged in one or more rings. |
| aryl | monovalent arene radical |
| arylene | bivalent arene radical |
| alkylaryl | monovalent arene radical that is substituted |
| | with at least one alkyl radical, i.e. a radical |
| | of formula: alkyl-arylene- |
| heteroarene | arene wherein at least one of the carbon atoms |
| | forming the ring(s) is replaced by a heteroatom |
| heteroaryl | monovalent heteroarene radical |

It is to be noted that, unless otherwise specified, the hydrocarbon chains of the above radicals can be linear or branched, preferably linear. Further, unless otherwise specified, these hydrocarbon chains can contain between 1 and 18 carbon atoms, more specifically between 6 and 18 carbon atoms, between 8 and 16 carbon atoms, between 10 and 14 carbon atoms, or preferably contain 12 carbon atoms.

It is to be noted that, unless otherwise specified, each ring of the above radicals can comprise between 4 and 8 ring atoms, preferably 5 or 6 ring atoms. Also, each of the above cyclic radicals may comprise more than one ring. In other words, they can be polycyclic. Preferably, the above cyclic radicals comprise only one ring. Herein, a “ring atom”, such as a ring carbon atom or a ring heteroatom, refers to an atom that forms (with other ring atoms) a ring of a cyclic compound, such as a cycloalkyl, an aryl, etc.

Herein, at “heteroatom” is an atom other than a carbon atom or a hydrogen atom. Preferably, the heteroatom is oxygen, nitrogen, or sulfur.

Herein, a “group substituted with one or more halogen atom” means that one or more hydrogen atoms of the group are replaced with halogen atoms, the same or different, preferably the same. When the group is substituted with one or more fluorine atoms, the group is said to be “fluorinated”; when all the available hydrogen atoms of the group are replaced with fluorine atoms, the group is said to be “perfluorinated”.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### Example 1 (Comparative)—Synthesis of Lanthanum Phenolate Catalyst

In a 250 mL Erlenmeyer loaded with a magnetic stirred bar, 1.70 g of sodium phenolate trihydrate were dissolved in 75 mL of deionized water. Another solution of lanthanum (Ill) nitrate hexahydrate (1.44 g) and 25 mL of deionized water was prepared and then added into the Erlenmeyer while stirring. After 30 min of stirring, the mixture was placed in the refrigerator (−1±1° C.) for 3 h and the solid formed was recovered by Büchner filtration (qualitative filter) and washed 3 times with 20 mL of deionized water. The solid was then dried in a vacuum oven (50 Torr, 60° C.) for 24 hours, giving 0.71 g of a brownish powder.

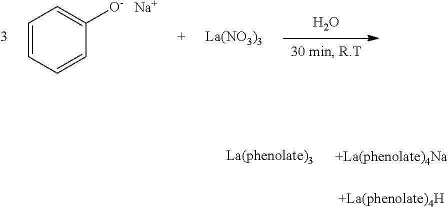

### Example 2—Synthesis of Lanthanum Dodecylbenzene Sulfonate (DBS) Catalyst

In a 250 mL Erlenmeyer loaded with a magnetic stirred bar, 3.48 g of sodium dodecylbenzene sulfonate were dissolved in 75 mL of deionized water. Another solution of lanthanum (Ill) nitrate hexahydrate (1.44 g) and deionized water (25 mL) was prepared and then added into the Erlenmeyer while stirring. After 30 min of stirring, the mixture was placed in the refrigerator (−1±1° C.) for 12 h. Once the ice was melted, the solid was recovered by Büchner filtration (qualitative filter) and washed 3 times with 20 mL of deionized water. The solid was then dried in a vacuum oven (50 Torr, 60° C.) for 24 hours, giving 2.29 g of a yellowish-white powder.

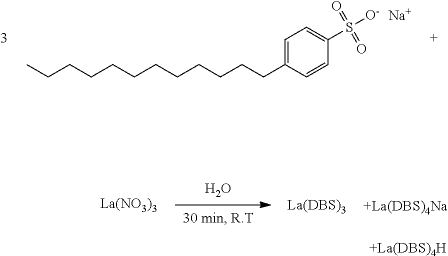

### Example 3 (Comparative)—Synthesis of Lanthanum Octanoate Catalyst

In a 250 mL Erlenmeyer loaded with a magnetic stirred bar, 0.868 g of octanoic acid was dissolved in 30 mL of deionized water. A second solution of 0.243 g of sodium hydroxide in 20 mL of deionized water was prepared and then added into the Erlenmeyer while stirring at room temperature. After 2 min of stirring, a third solution containing 1.44 of Lanthanum (Ill) nitrate hexahydrate and 25 mL of deionized water was prepared and added into the Erlenmeyer while stirring at room temperature. The mixture was stirred for another 30 min and the solid formed was recovered by Buchner filtration (qualitative filter) and washed 3 times with 20 mL of deionized water. The solid was then dried in a vacuum oven (50 Torr, 60° C.) for 24 hours, giving 1.04 g of a white powder.

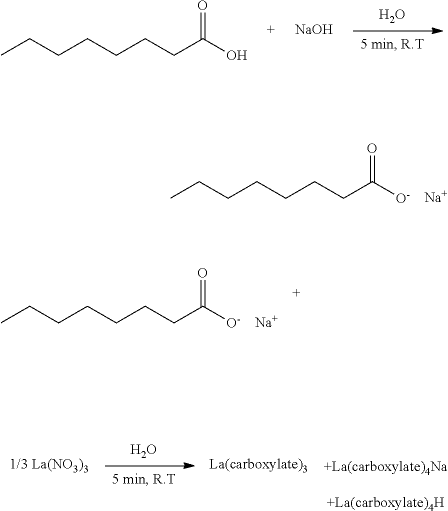

### Example 4—Synthesis of Various Metal Dodecyl Sulfate (DS) Catalysts

### Examples 4.1—Lanthanum Dodecyl Sulfate Catalyst

In a 125 mL Erlenmeyer loaded with a magnetic stirred bar, 0.999 g of sodium dodecyl sulfate were dissolved in 37.5 mL of deionized water at room temperature. Another aqueous solution was prepared by dissolving 0.500 g of lanthanum (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.055 g of a white powder.

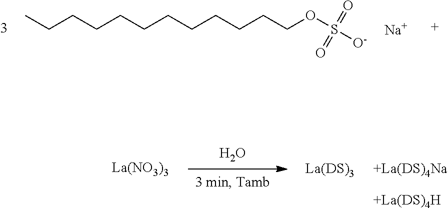

### Example 4.2—Cerium Dodecyl Sulfate Catalyst: Ce(DS)₃+Ce(DS)₄Na+Ce(DS)₄H

In a 125 mL Erlenmeyer loaded with a magnetic stirred bar, 0.996 g of sodium dodecyl sulfate were dissolved in 37.5 mL of deionized water at room temperature. Another aqueous solution was prepared by dissolving 0.500 g of cerium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.036 g of a white powder.

### Example 4.3—Praseodymium Dodecyl Sulfate Catalyst: Pr(DS)₃+Pr(DS)₄Na+Pr(DS)₄H

In a 125 mL Erlenmeyer loaded with a magnetic stirred bar, 0.994 g of sodium dodecyl sulfate were dissolved in 37.5 mL of deionized water at room temperature. Another aqueous solution was prepared by dissolving 0.500 g of praseodymium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.037 g of a greenish powder.

### Example 4.4—Neodymium Dodecyl Sulfate Catalyst: Nd(DS)₃+Nd(DS)₄Na+Nd(DS)₄H

In a 125 mL Erlenmeyer loaded with a magnetic stirred bar, 0.987 g of sodium dodecyl sulfate were dissolved in 37.5 mL of deionized water at room temperature. Another aqueous solution was prepared by dissolving 0.500 g of neodymium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.036 g of a pale magenta powder.

### Example 4.5—Samarium Dodecyl Sulfate Catalyst: Sm(DS)₃+Sm(DS)₄Na+Sm(DS)₄H

In a 125 mL Erlenmeyer loaded with a magnetic stirred bar, 0.973 g of sodium dodecyl sulfate were dissolved in 37.5 mL of deionized water at room temperature. Another aqueous solution was prepared by dissolving 0.500 g of samarium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.008 g of an ivory powder.

### Example 4.6—Europium Dodecyl Sulfate Catalyst: Eu(DS)₃+Eu(DS)₄Na+Eu(DS)₄H

In a 125 mL Erlenmeyer loaded with a magnetic stirred bar, 0.970 g of sodium dodecyl sulfate were dissolved in 37.5 mL of deionized water at room temperature. Another aqueous solution was prepared by dissolving 0.500 g of europium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.025 g of a white powder.

### Example 4.7—Gadolinium Dodecyl Sulfate Catalyst: Gd(DS)₃+Gd(DS)₄Na+Gd(DS)₄H

In a 125 mL Erlenmeyer loaded with a magnetic stirred bar, 0.961 g of sodium dodecyl sulfate were dissolved in 37.5 mL of deionized water at room temperature. Another aqueous solution was prepared by dissolving 0.500 g of gadolinium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.019 g of a white powder.

### Example 4.8—Terbium Dodecyl Sulfate Catalyst: Tb(DS)₃+Tb(DS)₄Na+Tb(DS)₄H

In a 125 mL Erlenmeyer loaded with a magnetic stirred bar, 0.955 g of sodium dodecyl sulfate were dissolved in 37.5 mL of deionized water at room temperature. Another aqueous solution was prepared by dissolving 0.500 g of terbium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 0.962 g of a white powder.

### Example 4.9—Holmium Dodecyl Sulfate Catalyst: Ho(DS)₃+Ho(DS)₄Na+Ho(DS)₄H

In a 125 mL Erlenmeyer loaded with a magnetic stirred bar, 0.981 g of sodium dodecyl sulfate were dissolved in 37.5 mL of deionized water at room temperature. Another aqueous solution was prepared by dissolving 0.500 g of holmium (Ill) nitrate hydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 0.996 g of a pale orange powder.

### Example 4.10—Erbium Dodecyl Sulfate Catalyst: Er(DS)₃+Er(DS)₄Na+Er(DS)₄H

In a 125 mL Erlenmeyer loaded with a magnetic stirred bar, 0.976 g of sodium dodecyl sulfate were dissolved in 37.5 mL of deionized water at room temperature. Another aqueous solution was prepared by dissolving 0.500 g of erbium (Ill) nitrate hydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.017 g of a pale pink powder.

### Example 4.11—Thulium Dodecyl Sulfate Catalyst: Tm(DS)₃+Tm(DS)₄Na+Tm(DS)₄H

In a 125 mL Erlenmeyer loaded with a magnetic stirred bar, 0.934 g of sodium dodecyl sulfate were dissolved in 37.5 mL of deionized water at room temperature. Another aqueous solution was prepared by dissolving 0.500 g of thulium (Ill) nitrate hexahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 0.974 g of a white powder.

### Example 4.12—Ytterbium Dodecyl Sulfate Catalyst: Yb(DS)₃+Yb(DS)₄Na+Yb(DS)₄H

In a 125 mL Erlenmeyer loaded with a magnetic stirred bar, 0.963 g of sodium dodecyl sulfate were dissolved in 37.5 mL of deionized water at room temperature. Another aqueous solution was prepared by dissolving 0.500 g of ytterbium (Ill) nitrate pentahydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.019 g of a white powder.

### Example 4.13—Lutetium Dodecyl Sulfate Catalyst: Lu(DS)₃+Lu(DS)₄Na+Lu(DS)₄H

In a 125 mL Erlenmeyer loaded with a magnetic stirred bar, 0.922 g of sodium dodecyl sulfate were dissolved in 37.5 mL of deionized water at room temperature. Another aqueous solution was prepared by dissolving 0.500 g of lutetium (Ill) nitrate hydrate in 12.5 mL of deionized water, and then added into the Erlenmeyer while stirring. After 3 min of stirring, the solid formed was recovered by Buchner filtration over a qualitative filter and washed 3 times with 25 mL of deionized water. The solid was then dried in a vacuum oven (50 Torr, 60° C.) for 24 hours, giving 1.005 g of a white powder.

### Example 5—Gel-Timer: Procedure and Results

In all cases, the catalyst (or accelerator) was incorporated into the curing agent (Epikure 3251 or Polyethylenimine) in a 20 mL vial with the help of heated sonic bath until a homogeneous solution was reached. The epoxy resin (Bisphenol A diglycidyl ether or Limonene dioxide) was then added into the previous mixture (curing agent and catalyst). Using a wire stirrer, the mixture was roughly pre-mixed before the beginning of the test.

The industrial formulation comprised the two following industrial components: Bisphenol A diglycidyl ether (BADGE, CAS: 1675-54-3) and Epikure™ curing agent 3251 (Hexion). All gel-time associated with this formulation were measured in a water bath at 25±2° C.

The bio-based formulation comprised the two following components: Limonene dioxide (LDO, CAS: 96-08-2) and Polyethylenimine (branched, Mw≈800 g/mol). All gel-time associated with this formulation were measured in a sand bath at 60° C.±2° C.

### Example 5.1—Gel-Time Obtained with the Dodecyl Sulfates Catalysts in the Industrial Formulation

| Dodecyl | | | | | | | | | | | | | |
|---|---|---|---|---|---|---|---|---|---|---|---|---|---|
| sulfates catalysts | La | Ce | Pr | Nd | Sm | Eu | Gd | Tb | Ho | Er | Tm | Yb | Lu |
| Example | 4.1 | 4.2 | 4.3 | 4.4 | 4.5 | 4.6 | 4.7 | 4.8 | 4.9 | 4.10 | 4.11 | 4.12 | 4.13 |
| Mass of | 3.40 | | | | | | | | | | | | |
| BADGE (g) | | | | | | | | | | | | | |
| Mass of Epikure | 1.52 | | | | | | | | | | | | |
| 3251 (g) | | | | | | | | | | | | | |
| Mass of catalyst | 0.10 (≈2% wt) | | | | | | | | | | | | |
| (g) | | | | | | | | | | | | | |
| Gel-time (min)^{a} | 24 | 50 | 44 | 47 | 43 | 57 | 56 | 62 | 62 | 63 | 53 | 51 | 64 |

^{a}The reference gel-time for the uncatalyzed reaction was 84 min.

### Example 5.2—Gel-Time Obtained with the Dodecyl Sulfates Catalysts in the Bio-Based Formulation

| Dodecyl | | | | | | | | | | | | | |
|---|---|---|---|---|---|---|---|---|---|---|---|---|---|
| sulfates catalysts | La | Ce | Pr | Nd | Sm | Eu | Gd | Tb | Ho | Er | Tm | Yb | Lu |
| Example | 4.1 | 4.2 | 4.3 | 4.4 | 4.5 | 4.6 | 4.7 | 4.8 | 4.9 | 4.10 | 4.11 | 4.12 | 4.13 |
| Mass of | 3.00 | | | | | | | | | | | | |
| LDO (g) | | | | | | | | | | | | | |
| Mass of | 2.00 | | | | | | | | | | | | |
| Polyethylenimine | | | | | | | | | | | | | |
| (g) | | | | | | | | | | | | | |
| Mass of catalyst | 0.92 (≈15.5% wt) | | | | | | | | | | | | |
| (g) | | | | | | | | | | | | | |
| Gel-time (h)^{a} | 6 | 10 | 11 | 12 | 12 | 16 | 25 | 12 | 15 | 16 | 18 | 15 | 13 |

b: The reference gel-time for the uncatalyzed reaction was 48 h min.

Example 5.1 and 5.2 shows that lanthanum-based catalyst appeared to be the most efficient catalyst (with the lower gel-time) tested in theses conditions among the lanthanide catalysts prepared

### Example 5.3—Comparison of Lanthanum Dodecyl Sulfate Catalyst with Conventional Accelerators—Industrial Formulation

The performances of lanthanum dodecyl sulfate were compared with those of other conventional accelerators:
BzOH: Benzyl alcohol,
DMP-30: 2,4,6-Tris(dimethylaminomethyl)phenol,
DABCO: 1,4-Diazabicyclo[2.2.2]octane and
Zn(Otf)₂: Zinc trifluoromethanesulfonate.

| Catalysts/ | Lanthanum | | | | | |
|---|---|---|---|---|---|---|
| accelerators | dodecyl sulfate | BzOH | Triethanolamine | DMP-30 | DABCO | Zn(Otf)₂ |
| Example | 4.1 | Comparative | Comparative | Comparative | Comparative | Comparative |
| Mass of BADGE | 3.40 | | | | | |
| (g) | | | | | | |
| Mass of Epikure | 1.52 | | | | | |
| 3251 (g) | | | | | | |
| Mass of catalyst | 0.10 (≈2% wt) | | | | | |
| (g) | | | | | | |
| Gel-time (min)^{a} | 24 | 67 | 60 | 52 | 75 | 50 |

^{a}The reference gel-time for the uncatalyzed reaction was 84 min.

Lanthanum dodecyl sulfate catalyst show a good ability to accelerate the gel-time in comparison with common accelerators, such as alcohols or Lewis acid and base, used in the same proportion.

### Example 5.4—Comparison of Lanthanum Dodecyl Sulfate Catalyst with Other Lanthanum Based Catalysts and Aluminium Dodecylsulfate Catalyst

| | Lanthanum | | Lanthanum | | Aluminium |
|---|---|---|---|---|---|
| | dodecyl | Lanthanum | dodecylbenzene | Lanthanum | dodecyl |
| Catalysts/accelerators | sulfate | phenolate | sulfonate | Octanoate | sulfate |
| Example | 4.1 | 1 - | 2 | 3 - | Comparative |
| | | Comparative | | Comparative | |
| Mass of BADGE (g) | 3.40 | | | | |
| Mass of Epikure 3251 (g) | 1.52 | | | | |
| Mass of catalyst (g) | 0.10 (≈2% wt) | | | | |
| Gel-time (min)^{a} | 24 | 55 | 43 | 58 | 53 |

^{a}The reference gel-time for the uncatalyzed reaction was 84 min.

Lanthanum dodecyl sulfate appeared to be the most efficient catalyst in comparison with the other lanthanum-based catalysts prepared.

### Example 6—Effect of Lanthanum Dodecyl Sulfate Catalysts on Drying Time (Tdry)

Those tests were realized with two commercial formulations. Formulation 1 was the two-part epoxy Alsan Floor® EP 101 from the company Soprema®. Formulation 2 was the two-part epoxy Alsan Floor® EP 902 from the same company.

In both case, lanthanum dodecyl sulfate catalyst was dispersed into the Part B of the formulations using a pneumatic mixer until disappearance of any visible solid particles. Pot-life have been measured over a 100 g formulation at room-temperature using a gel timer instrument. Drying time of the surface and the core have been evaluated over 10 mils films with a BK Dryer from the Gardco® company at room-temperature, and following ASTM D5895.

The result show that the addition of the lanthanum catalyst results in a measurable drying time decrease.

| | | Formulation 1 + | | Formulation 2 + |
|---|---|---|---|---|
| | | lanthanum dodecyl | | lanthanum dodecyl |
| | Formu- | sulfate catalyst | Formu- | sulfate catalyst |
| Resin | lation 1 | (Example 4.1) | lation 2 | (Example 4.1) |
| Mass of Part A (g) | 103.5 | | 108.6 | |
| Mass of Part B (g) | 46.5 | | 41.4 | |
| Mass of catalyst (g) | 0 | 4.674 | 0 | 4.278 |
| | | (=2% wt) | | (=2% wt) |
| Pot Life (min) | 18 | 12.5 | 180 | 61 |
| Drying time (Tdry) | 2.75/3.5 | 2.25/3 | 11/12 | 9.5/10 |
| (h/h) surface/core | | | | |

### Example 7—Effect of Lanthanum Dodecyl Sulfate Catalysts on Drying Time (Tdry)

Those tests were realized with part A containing 6.81 g diglycidyl ether bisphenol A, and part B containing 3.04 g of Epikure 3251 as well as a given amount of lanthanum dodecyl sulfate (Example 4.1). Lanthanum dodecyl sulfate catalyst was dispersed into the Part B of the formulations using a sonicating probe (100 W) until the solution was transparent. Drying time of the surface and the core have been evaluated over 10 mils films with a BK Dryer from the Gardco® company at room-temperature, and following ASTM D5895.

The result show that the addition of the lanthanum catalyst results in a measurable drying time decrease.

| | | Formulation 1 + | Formulation 1 + |
|---|---|---|---|
| | | lanthanum dodecyl | lanthanum dodecyl |
| | Formu- | sulfate catalyst | sulfate catalyst |
| Resin | lation 1 | (Example 4.1) | (Example 4.1) |
| Mass of Part A (g) | 6.21 | | |
| Mass of Epikure (g) | 3.04 | | |
| Mass of catalyst (g) | 0 | 0.1 | 0.2 |
| Drying time (Tdry) | 2/3 | 1.5/2 | 1/1.5 |
| (h/h) surface/core | | | |

### Example 8—Effect of Lanthanum Dodecyl Sulfate Catalysts on Curing Time, as Measured by Differential Scanning Calorimetry

The measurement of the heat released during the formation of a cross-linked epoxy network by differential scanning calorimetry is a usual technique to assess the kinetics of the reaction. Such technique is extensively described in (P. I. Karkanas, Polym. Int., 1996, 41, 183-191). The kinetic data were analyzed using the so-called Kamal model, where the conversion is fitted by a non auto-catalytic pathway (kinetic rate constant k₁, order n₁) and an auto-catalytic pathway (kinetic rate constant k₂, orders n₂ and m₂)

$$\frac{dx}{dt} = {{k}_{1} ( 1 - x )}^{{n}_{1}} + {k}_{2} {{x}^{{m}_{2}} ( 1 - x )}^{{n}_{2}}$$

The measurements were performed on a DSC 7 from Mettler-Toledo under nitrogen flux of 20 mL/min equipped with an autosampler and a cooler. A sample containing 6 g of limonene dioxide and 4 g of polyethylene imine (branched, Mw≈800 g/mol) was vigorously mixed using a vortex for 2 min. This sample was used as reference sample. Other samples were prepared with the same amounts of limonene dioxide and of polyethylene imine and 200 mg of metal dodecyl sulfate where the metal is either lanthanum, praesodium, gadolinium or europium, as respectively described in examples 4.1, 4.3, 4.7 and 4.6.

A precise amount of the homogeneous and viscous formulation, comprised between 8.1 mg and 13.2 mg, was measured in an analytical microbalance and was then immediately placed in a DSC pan, which was hermetically sealed. The sample was then placed on the autosampler and was introduced in the oven which was pre-heated at the requested temperature. These temperatures are consigned in the table below. For each thermogram, the values of k₁, n₁ k₂, n₂ and m₂ were obtained by a non-linear fit, as described in P. I. Karkanas, Polym. Int., 1996, 41, 183-191.

| | No catalyst | | |
|---|---|---|---|
| Parameter | T = 173° C. | T = 188° C. | T = 203° C. |
| k₁ | 0.00045 | 0.0016 | 0.0037 |
| m₁ | 1.12 | 0.84 | 3.42 |
| k₂ | 0.0037 | 0.010 | 0.025 |
| m₂ | 0.43 | 0.630 | 0.89 |
| n₂ | 1.12 | 1.60 | 2.36 |
| Parameter | T = 109° C. | T = 139° C. | T = 169° C. |
| | 2 wt % lanthanum dodecyl sulfate | | |
| k₁ | 0 | 0.0078 | 0.087 |
| m₁ | 1.83 | 0.51 | 3.27 |
| k₂ | 0.099 | 0.33 | 0.91 |
| m₂ | 0.33 | 0.35 | 0.39 |
| n₂ | 1.69 | 1.82 | 1.92 |
| | 2 wt % praesodynium dodecyl sulfate | | |
| k₁ | 0.00023 | 0.0032 | 0.091 |
| m₁ | 0.90 | 0.35 | 3.26 |
| k₂ | 0.076 | 0.33 | 0.87 |
| m₂ | 0.23 | 0.35 | 0.41 |
| n₂ | 1.43 | 1.78 | 1.78 |
| | 2 wt % gadolinium dodecyl sulfate | | |
| k₁ | 0.0015 | 0.037 | 0.090 |
| m₁ | 0.086 | 1.07 | 3.27 |
| k₂ | 0.076 | 0.34 | 0.87 |
| m₂ | 0.23 | 0.44 | 0.39 |
| n₂ | 1.36 | 2.23 | 1.70 |
| | 2 wt % europium dodecyl sulfate | | |
| k₁ | 0.00060 | 0.0014 | 0.0066 |
| m₁ | 0.68 | 0.0028 | 0.0029 |
| k₂ | 0.067 | 0.36 | 0.89 |
| m₂ | 0.15 | 0.38 | 0.30 |
| n₂ | 1.30 | 1.98 | 1.71 |

From these data, it is apparent that the auto-catalytic pathway is the main reaction pathway under the assessed conditions (k₂≥k₁). The apparent activation energies for this autocatalytic pathway were calculated from the slope of the plot of the logarithm of k₂ versus 1/T. For the formulation devoid of catalyst, this activation energy is 112 kJ/mol. For the formulation containing 2 wt % of lanthanum dodecyl sulfate, this activation energy is 52 kJ/mol. For the formulation containing 2 wt % of praesodinium dodecyl sulfate or 2 wt % gadolinium dodecyl sulfate, this activation energy is 57 kJ/mol. For the formulation containing 2 wt % of europium dodecyl sulfate, this activation energy is 61 kJ/mol. The result show that the addition of the lanthanide catalyst results in a measurable activation energy decrease and a faster reaction at lower temperatures.

The scope of the claims should not be limited by the preferred embodiments set forth in the examples but should be given the broadest interpretation consistent with the description as a whole.

### REFERENCES

The present description refers to a number of documents, the content of which is herein incorporated by reference in their entirety. These documents include, but are not limited to, the following:
U.S. Pat. No. 5,135,994
US20100316875
Firouzabadi, H. Chem. Commun. 6, 789-791 (2005)
Firouzabadi, H. J. Mol. Catal. A Chem. 274 (1-2), 109-115, (2007)
Ghesti, G. F. Appl. Catal. A Gen. 355 (1-2), 139-147 (2009)
Kobayashi, S. J. Amercian Chem. Soc. 120, 8287-8288 (1998)
Kobayashi, S. Tetrahedron Lett., 39, 5389-5392 (1998)
Pereira, R. F. P. RSC Adv. 3 (5), 1420-1433 (2013)
Karkanas, P. I. Polym. Int., 41, 183-191 (1996)

1. A catalyst for accelerating the crosslinking of a reactive epoxy monomer, oligomer or polymer to form an epoxy thermoset resin, wherein said catalyst is a compound of formula (I):
MX_{y} (I)
wherein:
M represents a rare earth metal cation;
y represents an integer from 1 to 4 equal to the valency of the rare earth metal cation, and
X represents an anion of formula R—Z—O⁻, wherein:
R represents an alkyl, alkenyl, alkynyl, alkenynyl, cycloalkyl, cycloalkenyl, cycloalkynyl, cycloalkenynyl, aryl, heteroaryl, or alkylaryl radical, each of which being unsubstituted, and
—Z— represents —S(═O)₂— or —O—S(═O)₂—.

2. The catalyst of claim 1, wherein —Z— represents —O—S(═O)₂—.

3. The catalyst of claim 1, wherein M represents Sc, Y or a metal of the lanthanide series.

4. (canceled)

5. The catalyst of claim 1, wherein the hydrocarbon chain of the alkyl, alkenyl, alkynyl, alkenynyl, and alkylaryl radicals contain between 8 and 16 carbon atoms.

6. (canceled)

7. (canceled)

8. The catalyst of claim 1, wherein R represents an alkyl or alkylaryl radical.

9. The catalyst of claim 1, wherein R represents dodecyl or dodecylphenyl.

10. (canceled)

11. (canceled)

12. (canceled)

13. The catalyst of claim 1, wherein X represents:
an alkylaryl sulfonate (alkylaryl-S(═O)₂O⁻) anion; or
an alkyl sulfate (alkyl-O—S(═O)₂O⁻) anion.

14. The catalyst of claim 1, wherein X represents an alkyl sulfate (alkyl-O—S(═O)₂O⁻) anion.

15. The catalyst of claim 1, being a rare earth metal dodecyl sulfate or a rare earth metal dodecylbenzene sulfonate.

16. The catalyst of claim 1, further comprising a compound of formula (II):
MX_{z}L (II)
wherein:
L represents Na⁺, H⁺, or a combination thereof;
z is equal to y+1, and
M, X, and y are as defined in claim 1.

17. The catalyst of claim 16, wherein L represents a combination Na⁺ and H⁺.

18. An epoxy thermosetting resin formulation comprising a reactive epoxy monomer, oligomer or polymer and the catalyst of claim 1.

19. (canceled)

20. (canceled)

21. (canceled)

22. (canceled)

23. The formulation of claim 18, wherein the reactive epoxy monomer, oligomer or polymer is:
a bisphenol-based epoxy resin,
a novolak-based epoxy resin,
an aliphatic epoxy resin,
a halogenated epoxy resin, or
a glycidyl amine epoxy resin.

24. The formulation of claim 18, wherein the reactive epoxy monomer, oligomer or polymer is:
a bisphenol-based epoxy resin, or
an aliphatic epoxy resin.

25. The formulation of claim 18, further comprising one or more hardener.

26. The formulation of claim 25, wherein the hardener is a polyfunctional amine, an acid, an acid anhydride, a phenol, an alcohol or a thiol.

27. Use of the catalyst of claim 1 for accelerating the crosslinking of a reactive epoxy monomer, oligomer or polymer to form an epoxy thermoset resin.

28. A method of crosslinking a reactive epoxy monomer, oligomer or polymer to form an epoxy thermoset resin, the method comprising contacting the catalyst of claim 1 with the reactive epoxy monomer, oligomer or polymer and optionally, a hardener.

29. A method of accelerating the crosslinking of a reactive epoxy monomer, oligomer or polymer to form an epoxy thermoset resin, the method comprising contacting the catalyst of claim 1 with the reactive epoxy oligomer or polymer and optionally, a hardener.

30. The catalyst of claim 1, being lanthanum dodecyl sulfate or lanthanum dodecylbenzene sulfonate.
